(19) United States
(12) Patent Application Publication
(10) Pub. No.: US 2004/0191346 A1
(43) Pub. Date: Sep. 30, 2004

(54) Method and system for producing a spliceless tread ring of cured elastomeric material for assembly to a tire carcass

(75) Inventors: Mario Marangoni, Rovereto (IT); Vitantonio Magistrale, Frosinone (IT)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(73) Assignee: MARANGONI TREAD S.p.A., Ferentino (IT)

(21) Appl. No.: 10/746,125

(22) Filed: Dec. 24, 2003

(30) Foreign Application Priority Data
Dec. 24, 2002 (IT) TO2002A001123

(51) Int. Cl. B29C 35/02

(52) U.S. Cl. 425/28.1

(57) ABSTRACT

A method and system for producing a spliceless tread ring of cured elastomeric material, wherein the tread ring is produced by molding and curing a spliceless green ring obtained by continuously extruding and depositing a section directly onto a mold core of a centripetal press; the mold core being movable axially, with respect to a curing mold, between an extracted position for forming the green ring, and a withdrawn molding and curing position, and being rotated about its axis in the extracted position, so as to coil the section and form the green ring on the mold core.

The present invention relates to a method and system for producing a spliceless tread ring of cured elastomeric material for assembly to a tire carcass.

### BACKGROUND OF THE INVENTION

In U.S. Pat. No. 3,994,653, cured tread rings are produced using a centripetal press, in which a central mold core, having a substantially cylindrical outer surface, is fitted in rotary and axially sliding manner to a fixed outer annular curing mold comprising a number of segments, and a number of actuating devices, each fitted to a respective segment to move the segment, radially with respect to a longitudinal axis of rotation of the mold core, between an open position and a closed molding and curing position. The mold core is movable axially, with respect to the annular curing mold, between a molding and curing work position, in which the mold core is located inside the annular curing mold, and an extracted position, in which the mold core receives, directly on its cylindrical outer surface from an extruder outlet, a strip of elastomeric material which, following a complete turn of the mold core, and after the strip is cut and the ends spliced, defines a ring of green elastomeric material which can be cured directly inside the centripetal press by moving the mold core axially into the work position.

One drawback of using the centripetal press described in U.S. Pat. No. 3,994,653 lies in the resulting tread rings being spliced, i.e. intrinsically featuring structural irregularities.

### SUMMARY OF THE INVENTION

It is an object of the present invention to improve the known centripetal press described above, and the way in which it is used, to provide a method of producing tread rings of cured elastomeric material, which is cheap and easy to implement, and at the same time produces spliceless tread rings.

According to the present invention, there is provided a method of producing tread rings of cured elastomeric material, as claimed in claim 1, and preferably as claimed in any one of the following claims depending directly or indirectly on claim 1.

According to the present invention, there is also provided a tread ring of cured elastomeric material, as claimed in claim 18, and preferably as claimed in any one of the following claims depending directly or indirectly on claim 18.

According to the present invention, there is also provided a system for producing a tread ring of cured elastomeric material, as claimed in claim 27, and preferably as claimed in any one of the following claims depending directly or indirectly on claim 27.

### BRIEF DESCRIPTION OF THE DRAWINGS

A number of non-limiting embodiments of the present invention will be described by way of example with reference to the accompanying drawings, in which:

FIG. 1 shows a schematic plan view, with parts removed for clarity, of a preferred embodiment of the system for producing tread rings according to the present invention;

FIG. 2 shows a schematic axial section of a first detail of the FIG. 1 system;

FIG. 3 shows a schematic view in perspective of a second detail of the FIG. 1 system;

FIG. 4 shows a schematic side view of a third detail of the FIG. 1 system;

FIG. 5 shows a schematic, partly sectioned view in perspective of a tread ring produced on the FIG. 1 system equipped with the FIG. 4 detail;

FIG. 6 shows a variation of the FIG. 4 detail;

FIG. 7 shows a schematic, partly sectioned view in perspective of a tread ring produced on the FIG. 1 system equipped with the FIG. 6 detail.

### DETAILED DESCRIPTION OF THE INVENTION

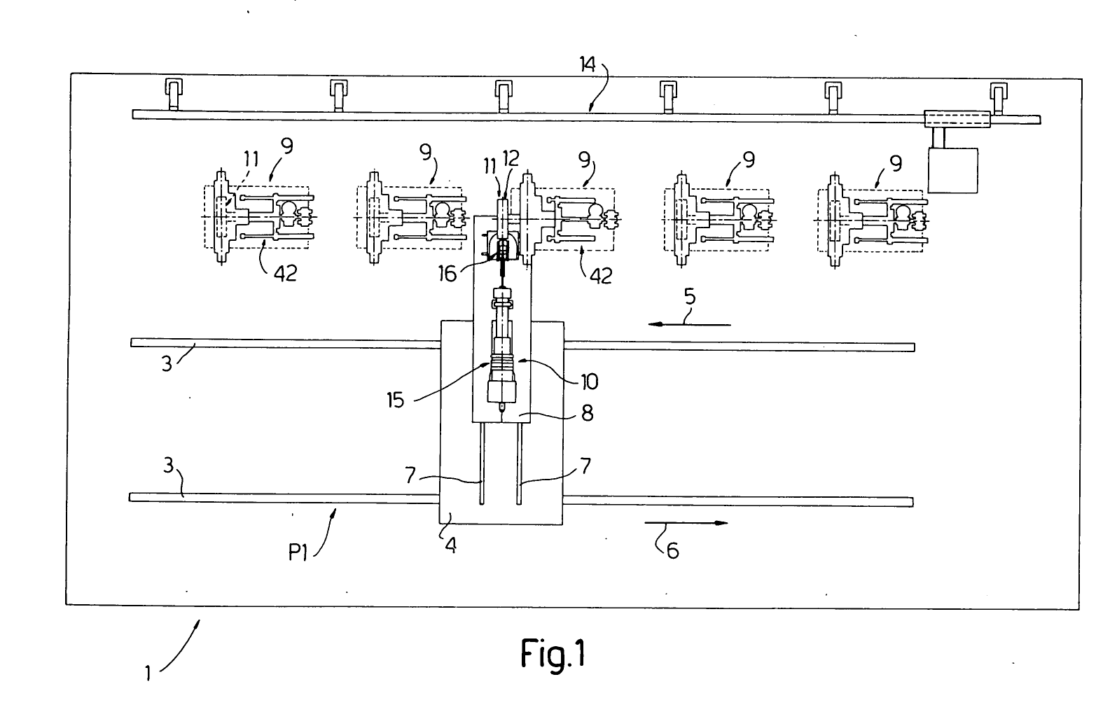

Number 1 in FIG. 1 indicates as a whole a system for producing tread rings 2 (FIGS. 5 and 7) of cured elastomeric material.

System 1 comprises two rails 3 defining a path P1 for a powered truck 4, which performs, along rails 3, a forward work run in a direction 5, and a return run in an opposite direction 6 to direction 5. That is, path P1 is in the form of an endless path, a work portion of which, traveled in direction 5, coincides with a return portion traveled in direction 6.

Truck 4 is fitted with a further two rails 7 extending crosswise to rails 3 and supporting a further powered truck 8, which moves along rails 7 between a withdrawn rest position (not shown) on truck 4, and an extracted work position, in which truck 8 projects outwards of rails 3.

System 1 also comprises a number of molding and curing stations 9 equally spaced along rails 3, on the side of rails 3 on which truck 8, in the extracted work position, projects with respect to truck 4.

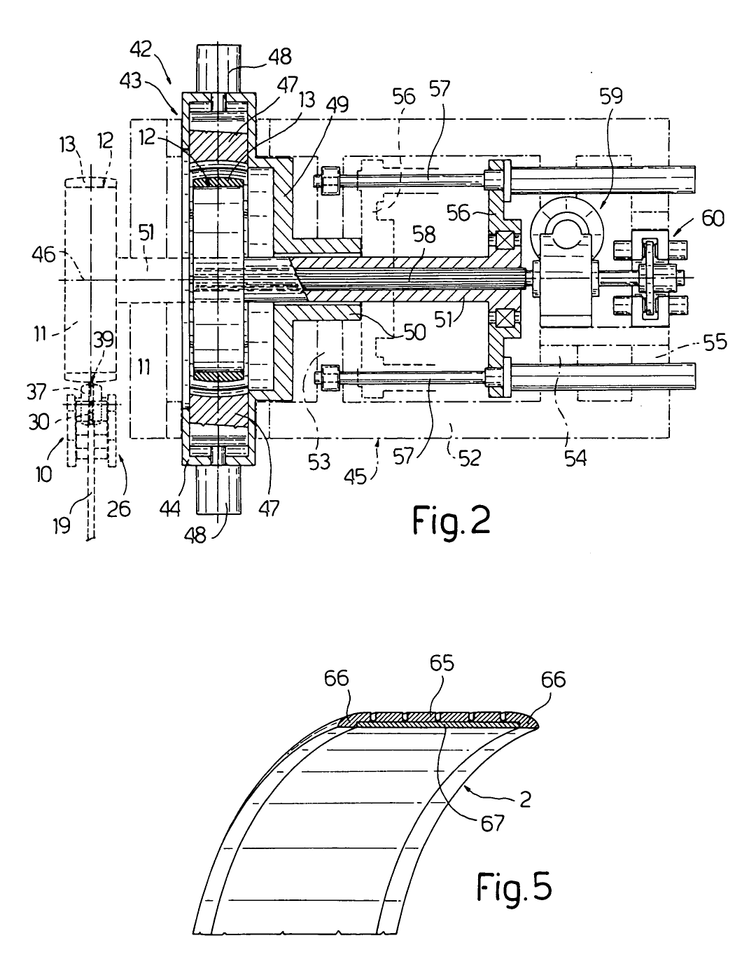

System 1 also comprises a forming unit 10 supported on truck 8, and which is arrested selectively by truck 8 at each work station 9 to cooperate, in that position, with a forming support 11 forming part of the relative work station 9 and having a substantially cylindrical outer surface 12, and to hot form a ring 13 (FIGS. 2 and 4) of green elastomeric material directly on outer surface 12 of forming support 11.

Finally, system 1 comprises a conveying unit 14 extending parallel to rails 3, on the opposite side of work stations 9 to rails 3, to receive and carry off the tread rings 2 produced at work stations 9.

As shown in FIGS. 1 and 4, forming unit 10 is substantially defined by a forming machine 10a comprising an extrusion unit 15 mounted in a fixed position on truck 8, crosswise to rails 3, and for forming green elastomeric material, and a turret 16 located to the front of extrusion unit 15. In the example shown, extrusion unit 15 comprises two superimposed extrusion heads 17 and 18 (supplied by respective extruders not shown) facing turret 16 and for producing respective continuous sections 19 and 20 of green elastomeric material from normally, though not necessarily, different mixes.

As shown more clearly in FIG. 4, turret 16 comprises a hollow base 21 extending upwards, from a powered turntable 22 (optional), which rotates about a vertical axis 23 and is supported on a powered truck 24 movable along two rails 25 fitted to truck 8 and parallel to rails 3. In the absence of turntable 22, turret 16 is supported directly on truck 24.

Turret 16 also comprises a top work head 26, in turn comprising a frame 27 connected to the top of base 21 with the interposition of a guide-slide coupling 28 enabling work head 26 to move, with respect to base 21, in a direction parallel to rails 7 and crosswise to axis 23. Frame 27 is fitted with a shaping unit 29 for receiving sections 19 and 20 and converting them into respective further sections 30 and 31 of given cross section. For which purpose, shaping unit 29 comprises two superimposed calenders 32 and 33 for receiving and shaping respective sections 19 and 20.

Each calender 32, 33 comprises a drive roller 34 and a driven roller 35, which are tangent to each other, are both powered (via a known transmission not shown) by a motor 36 housed vertically inside base 21, and are shaped laterally to define, in between, a channel of desired cross section, which is engaged at the input by relative section 19, 20, and supplies respective section 30, 31 at the output.

Work head 26 also comprises a substantially cylindrical applicator roller 37 fitted to frame 27 to rotate, with respect to frame 27, about an axis 38 parallel to rails 25, and which is also connected in known manner (not shown) to motor 36.

On leaving shaping unit 29, sections 30 and 31 are fed along respective paths P2 and P3—of which at least path P2 is preferably defined by a guide 30a extending from shaping unit 29—and, one on top of the other, onto the periphery of applicator roller 37, which applies them simultaneously at an application point 39, onto outer surface 12 of forming support 11. In other words, paths P2 and P3 have a common end portion extending along the periphery of applicator roller 37, and enable the formation of a composite section 40 having an outer layer defined by section 31, and an inner layer defined by section 30, so that, as explained in more detail later on, a multilayer green ring 13 is gradually formed on forming support 11.

Work head 26 also comprises a cutting unit 41a cooperating with the periphery of applicator roller 37 along the common end portion of paths P2 and P3; and preferably, though not necessarily, a further cutting unit 41b located along the guide 30a defining path P2, and immediately upstream from applicator roller 37.

As shown in FIG. 1, each forming support 11 is defined by the inner mold core (hereinafter also indicated 11) of a respective centripetal molding and curing press 42 substantially defining respective work station 9.

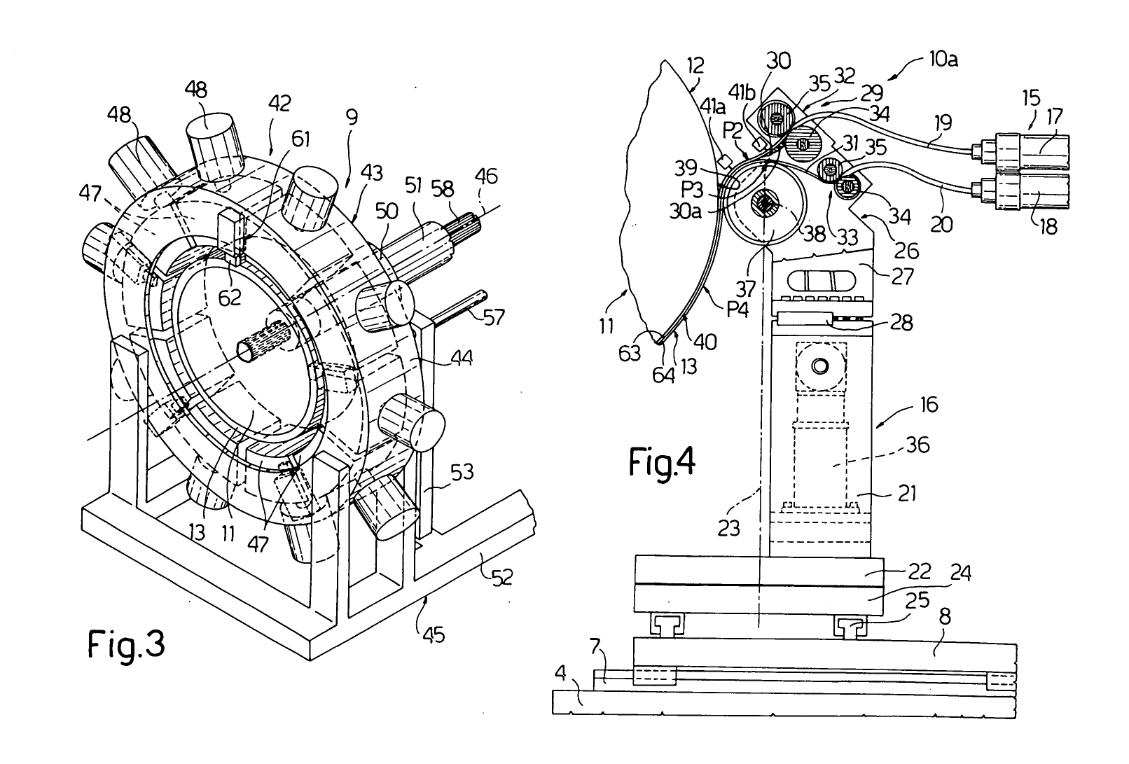

As shown more clearly in FIGS. 2 and 3, each centripetal press 42 comprises an annular curing mold 43, in turn comprising, in known manner, a toroidal body 44 supported in a fixed position on a base 45 and having an axis 46 parallel to rails 3, and a number of segments 47 fitted to toroidal body 44 and movable radially, with respect to toroidal body 44 and by respective actuators 48, between an open rest position and a closed molding and curing position. Toroidal body 44 is closed at the back by a bell 49 crosswise to axis 46 and having a central through sleeve 50 coaxial with axis 46 and projecting rearwards from a central portion of bell 49. An internally splined, tubular shaft 51 is fitted in rotary and axially sliding manner through sleeve 50, is coaxial with axis 46, and is fitted at the front end with mold core 11, the outer surface 12 of which is coaxial with axis 46.

As shown more clearly in FIG. 2, base 45 comprises a rear portion projecting rearwards of toroidal body 44, and in turn comprising a base frame 52 resting on the floor, and three gantry-type uprights 53, 54, 55 arranged successively behind bell 49 and crosswise to axis 46. Sleeve 50 extends through upright 53, and the rear end of tubular shaft 51 between uprights 53 and 54 is connected in rotary and axially fixed manner to a cross member 56 moved between uprights 53 and 54 by jacks 57, which are connected integrally to upright 53, are connected in sliding manner to uprights 54 and 55, and move mold core 11 along axis 46 between an extracted forming position (shown by the dash line in FIG. 2), in which mold core 11 is located to the front of annular mold 43 and completely outside toroidal body 44, and a central work position (shown by the continuous line in FIG. 2), in which mold core 11 is housed inside annular mold 43, between segments 47.

A splined, axially fixed shaft 58 is fitted inside tubular shaft, 51, is connected in axially sliding, angularly fixed manner to tubular shaft 51, and has a rear portion extending through a drive unit 59 fitted to upright 54 and for rotating splined shaft 58, and therefore mold core 11, about axis 46, and through a brake unit 60 fitted to upright 55 and for angularly locking splined shaft 58, and therefore mold core 11, in any given angular position about axis 46.

Along its front surface, toroidal body 44 has an “unseating” device 61 comprising a number of powered bolts 62 arranged about and radially with respect to axis 46, and movable, with respect to toroidal body 44, between an extracted work position, in which their free ends are substantially tangent to outer surface 12 of mold core 11, and a withdrawn rest position.

In actual use, when forming unit 10 is arrested at a work station 9, respective centripetal press 42 is set with segments 47 in the open position, and with mold core 11 in the extracted forming position. Once truck 4 is arrested, truck 8 is moved and guide-slide coupling 28 activated to bring applicator roller 37 of forming unit 10 (FIG. 4) substantially into contact with outer surface 12, and so bring composite section 40 into contact with outer surface 12 at application point 39. At this point, extrusion unit 15 and drive unit 59 are operated simultaneously to rotate mold core 11 about axis 46 and wind composite section 40 about mold core 11. As extrusion unit 15 and drive unit 59 operate, truck 24 moves steadily along rails 25, so that application point 39 moves along a generating line of outer surface 12, composite section 40 is wound about mold core 11 along a substantially helical winding path P4, and green ring 13 is formed on mold core 11 within a given forming time, and comprises as shown in FIG. 4, an inner layer 63 defined by section 30, and an outer layer 64 defined by section 31.

Once green ring 13 is completed, drive unit 59 is stopped, brake unit 60 is activated to angularly lock mold core 11, and cutting unit 41a is activated to cut composite section 40 on the periphery of applicator roller 37, thus leaving forming unit 10 ready for the next application.

If only cutting unit 41a is provided, as in the above case, inner and outer layers 63 and 64 are the same width. If, however, both cutting units 41a and 41b are provided, cutting units 41a and 41b and the extruders (not shown) connected to respective extrusion heads 17 and 18 may be operated differently to obtain a green ring 13 (not shown) having an outer layer 64 (FIG. 4) wider than inner layer 63, and which maybe molded and cured to produce a tread ring 2 of the type shown in FIG. 5, in which, outer layer 64, once cured, defines an annular tread strip 65, the shoulders 66 of which extend laterally outwards of an annular base strip 67 defined by cured inner layer 63.

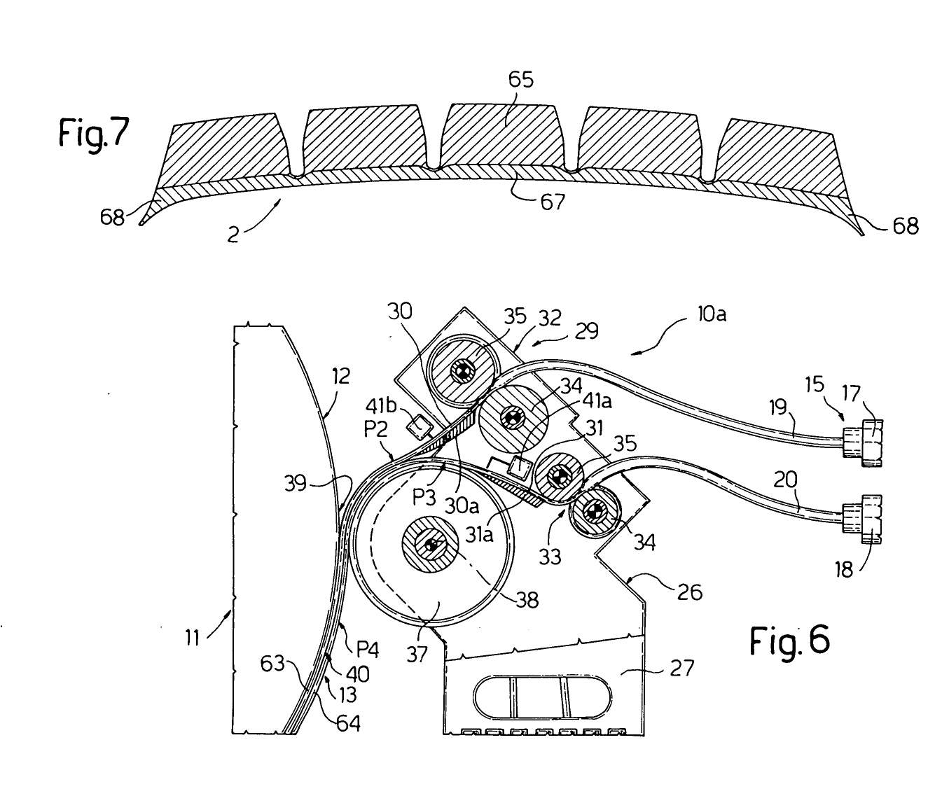

In the FIG. 6 variation, section 31 also has a guide 31a, and cutting unit 41a is moved to the output of guide 31a to cut section 31 only. In this way, differently operating cutting units 41a and 41b and the extruders (not shown) connected to respective extrusion heads 17 and 18 produces a green ring 13 (not shown) having an outer layer 64 narrower than inner layer 63, and which may be molded and cured to obtain a tread ring 2 of the type shown in FIG. 7, in which, inner layer 63, once cured, defines an annular base strip 67, the shoulders 68 of which extend laterally outwards of an annular tread strip 65 defined by the cured outer layer 64.

At this point, truck 4 is operated to move forming unit 10 to the next work station 9, where the above cycle is repeated; and, at the same time jacks 57 are operated to move mold core 11 axially into the central work position. Once mold core 11 is positioned, actuators 48 are operated to move segments 47 into the closed position to mold green ring 13, and segments 47 are kept in the closed position for a given curing time, long enough to form tread ring 2 of cured elastomeric material on mold core 11.

When curing is completed, segments 47 are moved back to the open position, and jacks 57 are operated to move mold core 11 back to the extracted position. During extraction, mold core 11 is first moved outwards past bolts 62 of unseating device 61 in the withdrawn position; after moving bolts 62 into the extracted position, mold core 11 is again moved towards toroidal body 44 to enable bolts 62 to engage tread ring 2 laterally and unseat it off mold core 11; and, after moving bolts 62 into the withdrawn position, mold core 11 is moved back into the extracted position ready for the next cycle.

Once unloaded off relative mold core 11, tread ring 2 is transferred, by a known transfer arm (not shown), to conveying unit 14, on which it is transferred to successive known finishing stations not shown.

The entire forming, molding, and curing cycle is repeated at each of work stations 9, which, to maximize the efficiency of system 1, are preferably of such a number that the sum of the respective forming times is at most equal to the curing time of each work station 9. In this way, after forming a green ring 13 in each of work stations 9 arranged successively along path P1, forming unit 10 can move back to the first work station 9 just as the relative tread ring 2 is being unloaded.

As will be clear from the foregoing description, at each work station 9, the relative green ring 13, once hot formed by extrusion unit 15 on mold core 11, is molded and cured immediately on mold core 11, without being removed, stored, or coated with liquid release agents.

Consequently, in addition to eliminating all the special machinery required to form green rings 13 according to the known art, and eliminating the storage space and use of pollutant liquid release agents, the forming heat (sections 30 and 31 are normally deposited on mold core 11 at a temperature close to 80-90° C.) is also saved, thus substantially halving both normal curing energy consumption and curing time.

Moreover, not being unloaded off the forming supports defined by mold cores 11, the resulting green rings 13 are spliceless and perfectly circular, undergo no undesired deformation prior to curing, and retain none other than a circular shape memory.

Finally, by retaining its forming heat when inserted inside annular mold 43, each green ring 13 is hot molded, thus eliminating any local impairment or disruption of the original longitudinal equiorientation of its molecular chains produced by extrusion of relative sections 19 and 20.

Clearly, numerous changes may be made, either singly or in any combination, to system 1 as described herein without, however, departing from the scope of the present invention.

In particular, the number of work stations 9 may differ from that shown. Even only one work station 9 may be provided; in which case, rails 3 and truck 4 may be dispensed with.

At least two trucks 4 with respective forming units 10 may be provided along path P1 to increase the number of work stations 9 along path P1 or to form layers 63 and 64 in two successive runs. In which latter case, work heads 26 of the two forming units 10 would be fitted one with calender 32 and the other with calender 33.

In a variation (not shown) of system 1 described, the addition of a turntable (not shown) between truck 4 and rails 7 provides for turning rails 7 through 180° about a vertical axis, so that work stations 9 can be arranged on both sides of rails 3 to double the number of work stations 9 or, for a given number of work stations 9, to substantially halve the length of rails 3 and hence the overall size of system 1.

In a further variation (not shown) of system 1 described, the same result is obtained by replacing rails 3 and truck 4 with a turntable (not shown) rotating in steps about a vertical axis and supporting even more than one forming unit 10, and by arranging work stations 9 about the turntable axis.

As regards forming unit 10, it should be pointed out that one of the two calenders 32, 33 may be eliminated or left idle together with the relative extrusion head 17, 18 when producing a single-layer green ring 13.

Finally, in each work station 9, the devices described and illustrated for moving forming support 11 axially with respect to relative annular mold 43, for rotating forming support 11 about axis 46, and for angularly locking forming support 11, may obviously differ entirely, both mechanically and structurally, from those described.

1 A method of producing a spliceless tread ring of cured elastomeric material, the method employing, in combination, forming means for extruding and calendering at least one section of green elastomeric material of a given cross section, and at least one centripetal curing press comprising an annular outer curing mold, which has a longitudinal axis and is defined by a number of segments, each movable radially, with respect to said longitudinal axis and by a respective actuating device, between an open position and a closed molding and curing position, and an inner mold core, which is fitted in rotary manner to said curing mold, has a substantially cylindrical outer surface coaxial with said longitudinal axis, and is movable along said longitudinal axis between an extracted position and a work position central with respect to said curing mold; the method comprising a forming step, in which said section is wound hot onto said mold core in the extracted position to gradually form, on the mold core, a spliceless ring of green elastomeric material; and a molding and curing step to mold and cure said ring of green elastomeric material on said mold core in said work position to form said tread ring of cured elastomeric material.

2 The method as claimed in claim 1, wherein said forming step comprises the substeps of:
setting said segments to said open position, and said mold core to said extracted position with said outer surface facing an output of said forming means;
applying one end of said section to a given point of application on said outer surface;
rotating the mold core about said longitudinal axis, so as to take said section with it, and simultaneously activating said forming means to continuously hot form said section;
effecting a relative translation movement between said forming means and said mold core to move said point of application along a generating line of said outer surface to wind said section about said longitudinal axis along a substantially helical winding path extending in contact with said outer surface, so as to gradually form said ring of green elastomeric material on said outer surface; and
arresting rotation of the mold core, deactivating said forming means and simultaneously cutting said section.

3 The method as claimed in claim 1, wherein said molding and curing step comprises the substeps of:
moving said mold core axially into the work position; and
moving said segments into the closed position to mold and cure said ring of green elastomeric material for a given curing time, and obtain said tread ring of cured elastomeric material.

4 The method as claimed in claim 1, and also comprising an unloading step, in turn comprising the substeps of:
moving said segments into the open position, and said mold core from the work position; and
unseating said tread ring of cured elastomeric material off the mold core by moving the mold core into the work position.

5 The method as claimed in claim 2, wherein said forming means comprise at least one forming machine having an output applicator device; and wherein said forming machine is positioned facing said outer surface when said mold core is in the extracted position; said forming machine comprising an extrusion unit for continuously producing at least one respective first section of green elastomeric material, and a shaping unit for converting said first section into a second section having a cross section of given shape and size; and said applicator device continuously hot depositing said second section, as it is formed, onto said outer surface at said point of application.

6 The method as claimed in claim 2, wherein said relative movement is effected by moving at least said applicator device with respect to said mold core and parallel to said longitudinal axis.

7 The method as claimed in claim 1, wherein said ring of green elastomeric material comprises at least two superimposed layers of respective green elastomeric materials, and is formed by hot depositing, onto said outer surface and for each said layer, a respective section of a respective said green elastomeric material; each said section being wound about said longitudinal axis along a respective substantially helical winding path.

8 The method as claimed in claim 7, wherein each said section is produced continuously by a respective extruding device, and is fed continuously to said mold core along a respective feed path.

9 The method as claimed in claim 8, wherein each said feed path extends through a respective calender for imparting a cross section of given shape and size to the relative said section.

10 The method as claimed in claim 7, wherein said superimposed layers are produced successively.

11 The method as claimed in claim 7, wherein said superimposed layers are produced, at least partly, simultaneously.

12 The method as claimed in claim 2, wherein said feed paths are superimposed, and have a common portion tangent to said outer surface at said point of application; said sections being fed, at least partly, simultaneously along the relative said feed paths to form, along said common portion, a composite section defined by said sections superimposed and contacting each other.

13 The method as claimed in claim 1, and employing a number of said centripetal curing presses located at respective work stations; the method comprising the steps of moving said forming means cyclically along a path extending along said work stations, and arresting said forming means at each said work station for a given forming time required to form a respective said ring of green elastomeric material on the relative mold core.

14 The method as claimed in claim 13, wherein said work stations are of such a number that the sum of the relative forming times at most equals said curing time.

15 The method as claimed in claim 13, wherein said path is an endless path.

16 The method as claimed in claim 15, wherein said path comprises a work portion extending along said work stations; and a return portion.

17 The method as claimed in claim 16, wherein said work portion and said return portion coincide with each other.

18 The spliceless tread ring of cured elastomeric material produced according to the method claimed in claim 1.

19 The tread ring as claimed in claim 18, and produced from a ring of green elastomeric material comprising at least one annular layer.

20 The tread ring as claimed in claim 19, wherein said annular layer is a spliceless annular layer.

21 The tread ring as claimed in claim 20, wherein said annular layer is defined by a coiled section.

22 The tread ring as claimed in claim 7 and 20, and produced from a ring of green elastomeric material comprising an outer annular layer and at least one inner annular layer superimposed on each other and made of respective elastomeric materials.

23 The tread ring as claimed in claim 22, wherein at least one of said two layers is defined by a section coiled about said mold core.

24 The tread ring as claimed in claim 22, and comprising an annular tread strip, and an annular base strip for said annular tread strip.

25 The tread ring as claimed in claim 24, wherein said annular tread strip and said annular base strip are of different widths.

26 The tread ring as claimed in claim 24, wherein said annular tread strip and said annular base strip are the same width.

27 A system for producing a spliceless tread ring of cured elastomeric material, the system comprising forming means for extruding and calendering at least one section of green elastomeric material of a given cross section, and at least one centripetal curing press; the centripetal curing press comprising a fixed outer annular curing mold, which has a longitudinal axis and comprises a number of segments and a number of actuating devices, each connected to a respective said segment to move the segment, radially with respect to said longitudinal axis, between an open position and a closed molding and curing position; a mold core coaxial with said longitudinal axis, having a substantially cylindrical outer surface, and fitted to said annular curing mold to rotate about said longitudinal axis and to translate along said longitudinal axis between an extracted position and a work position central with respect to said annular curing mold; first actuating means for moving said mold core axially between said extracted position and said work position; second actuating means for rotating said mold core about said longitudinal axis; and braking means for releasably locking said mold core in a given angular position with respect to said annular curing mold; and said forming means hot-feeding said section onto said outer surface when said mold core is in the extracted position.

28 The system as claimed in claim 27, wherein said forming means comprise at least one forming machine having an output positioned facing said outer surface when said mold core is in the extracted position; said forming machine comprising an extrusion unit for continuously producing at least one first section of green elastomeric material, a shaping unit for calendering said first section into a second section having a cross section of given shape and size, and an applicator device for continuously hot depositing said second section, as it is formed, onto said outer surface at a point of application; moving means being provided for moving said point of application continuously along a generating line of said outer surface during operation of said second actuating means, so that said second section winds about said outer surface along a substantially helical winding path.

29 The system as claimed in claim 28, wherein said forming machine comprises at least a first and a second extruding device, and said extrusion unit comprises at least a first and a second shaping device associated respectively with said first and said second extruding device to produce a respective said first section and then a respective said second section for supply to said applicator device along respective feed paths.

30 The system as claimed in claim 29, wherein said feed paths are superimposed, and have a common portion at said applicator device to enable the formation, along said common portion, of a composite section defined by said two second sections superimposed and contacting each other.

31 The system as claimed in claim 27, and comprising a number of said mold cores located at respective work stations; movable supporting means for moving said forming means cyclically along a path extending along said work stations, and for arresting said forming means at each said work station for a given forming time required to form a respective said ring of green elastomeric material on the relative mold core.

32 The system as claimed in claim 31, wherein said work stations are of such a number that the sum of the relative forming times at most equals said curing time.

33 The system as claimed in claim 31, wherein said path is an endless path.

34 The system as claimed in claim 33, wherein said path comprises a work portion extending along said work stations; and a return portion.

35 The system as claimed in claim 34, wherein said work portion and said return portion coincide with each other.
